(19) United States
(12) Patent Application Publication
(10) Pub. No.: US 2015/0382341 A1
(43) Pub. Date: Dec. 31, 2015

(54) FAST CHANNEL RESERVATION FOR WI-FI

(71) Applicants: QINGHUA LI, San Ramon, CA (US); PO-KAI HUANG, Santa Clara, CA (US); RONGZHEN YANG, Shanghai (CN); ROBERT STACEY, Portland, OR (US); HUANING NIU, Milpitas, CA (US); HUJIN YIN, Saratoga, CA (US)

(72) Inventors: QINGHUA LI, San Ramon, CA (US); PO-KAI HUANG, Santa Clara, CA (US); RONGZHEN YANG, Shanghai (CN); ROBERT STACEY, Portland, OR (US); HUANING NIU, Milpitas, CA (US); HUJIN YIN, Saratoga, CA (US)

(21) Appl. No.: 14/498,360

(22) Filed: Sep. 26, 2014

Related U.S. Application Data
(60) Provisional application No. 62/018,368, filed on Jun. 27, 2014.

(51) Int. Cl. H04W 72/04

(52) U.S. Cl. CPC H04W 72/0413; H04W 72/1284

(57) ABSTRACT

Methods, apparatus, and systems for fast channel reservation in a Wi-Fi environment are discussed. More specifically, a communication station arranged for Clear Channel Assessment (CCA) channel status reporting, an access point, and communication methodologies therebetween are disclosed. Methods, apparatus, and systems described herein can be applied to 802.11ax downlink MU-MIMO as well as uplink MU-MIMO, either separately or simultaneously.

### CROSS REFERENCE TO RELATED APPLICATIONS

This application claims the benefit of U.S. provisional Patent Application Ser. No. 62/018,368, filed on Jun. 27, 2014, the disclosure of which is incorporated herein by reference.

### TECHNICAL FIELD

Embodiments disclosed herein generally relate to wireless networks.

### BACKGROUND

A next generation WLAN, IEEE 802.11ax (HEW), is under development. Uplink multiuser MIMO (UL MU-MIMO) and OFDMA are two major features included in the new standard. For both features, the Access Point (AP) needs to schedule the transmissions or receptions of multiple users. This requires the AP to have channel status knowledge comprising Clear Channel Assessment (CCA) and buffer status of the user communication stations (STAs). If the AP allocates resource for the uplink transmission of a station whose buffer has no data, the allocated resource is wasted. Reporting the channel status to the AP consumes overhead that linearly increases with the number of users.

### BRIEF DESCRIPTION OF THE DRAWINGS

FIG. 1 is a network diagram illustrating an example network environment suitable for FTM Burst Management, according to one example embodiment;

FIG. 2 illustrates a high level diagram illustrating DL MU-MIMO operations where users or STAs are scheduled before a channel is reserved, according to one example embodiment;

FIG. 3 illustrates a DL MU-MIMO operation where a channel is reserved before users or STAs are scheduled by an access point, according to one example embodiment;

FIG. 4 illustrates a combined downlink/uplink scheduling and channel reservation, according to one example embodiment;

FIG. 5 illustrates a combined downlink/uplink scheduling and separated downlink/uplink channel reservation, according to one example embodiment;

FIG. 6 illustrates a UL MU-MIMO operation where a channel is reserved before users or STAs are scheduled by an access point, according to one example embodiment;

FIG. 7 illustrates a functional diagram of an exemplary communication station or exemplary access point, according to one example embodiment; and

FIG. 8 shows a block diagram of an example of a machine upon which, any of one or more techniques (e.g., methods) according to one or more embodiments discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The terms “communication station”, “station”, “handheld device”, “mobile device”, “wireless device” and “user equipment” (UE), as used herein, refer to a wireless communication device such as a cellular telephone, smartphone, tablet, netbook, wireless terminal, laptop computer, a wearable computer device, a femtocell, High Data Rate (HDR) subscriber station, access point, access terminal, or other personal communication system (PCS) device. The device may be either mobile or stationary.

The term “access point” (AP) as used herein may be any station. An access point may also be referred to as an access node, a base station, a mobile station in a mesh network, peer-to-peer network or some other similar terminology known in the art. An access terminal may also be called a mobile station, a user equipment (UE), a wireless communication device or some other similar terminology known in the art. Embodiments disclosed herein generally pertain to wireless networks. Some embodiments c a n relate to wireless networks that operate in accordance with one of the IEEE 802.11 standards including the IEEE 802.11ax standard or DensiFi. Other embodiments can relate to determination of communication status. Further, certain embodiments can relate to channel reservation during communication status determination.

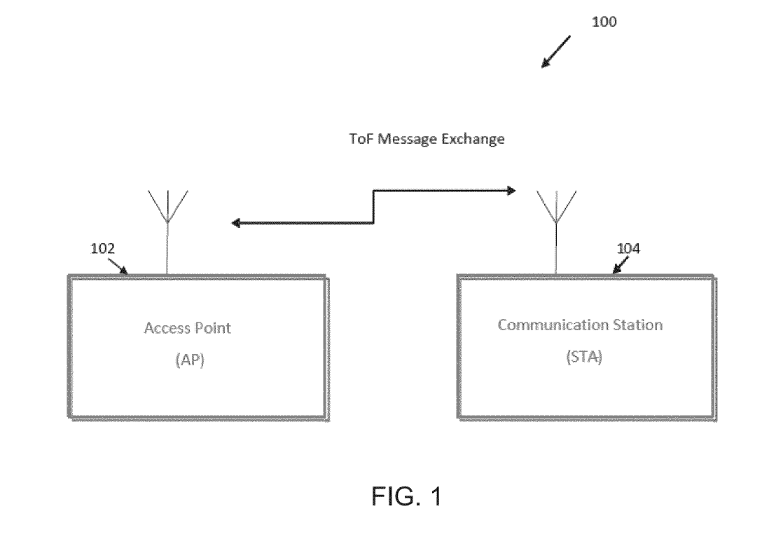

FIG. 1 is a network diagram illustrating an example network environment suitable for FTM Burst Management, according to some example embodiments. Wireless network 100 can include one or more communication stations (STAs) 104 and one or more access points (APs) 102, which may communicate in accordance with IEEE 802.11 communication techniques. The communication stations 104 may be mobile devices that are non-stationary and do not have fixed locations. The one or more APs may be stationary and have fixed locations. The stations may include an AP communication station (AP) 102 and one or more responding communication stations STAs 104.

In accordance with some IEEE 802.11ax (High-Efficiency Wi-Fi (HEW)) embodiments, an access point may operate as a master station which may be arranged to contend for a wireless medium (e.g., during a contention period) to receive exclusive control of the medium for an HEW control period (i.e., a transmission opportunity (TXOP)). The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations may refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique, which may also be referred to as multiuser MIMO.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In other embodiments, the links of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In certain embodiments, a 320 MHz contiguous bandwidth may be used. I n other embodiments, bandwidths of 5 MHz and/or 10 MHz may also be used. In these embodiments, each link of an HEW frame may be configured for transmitting a number of spatial streams.

Although Downlink Multiuser MIMO (DL MU-MIMO) was introduced to Wi-Fi in 802.11ac, features to prevent reception jamming caused by incorrect channel status assumptions were not addressed. There is no channel reservation scheme for DL MU-MIMO reception in existing Wi-Fi. Additionally, there is no polling scheme known in Wi-Fi for multiuser scheduling. Without protecting the receiver and polling the receiver, the system throughput can be lower than that with the protection/poll by 2× and more for long packets.

In certain of these scenarios, the access point (AP) sees an idle channel and directly sends downlink MU-MIMO data to the scheduled stations (STA) without checking the channel statuses of the STAs. Reception of the DL MU-MIMO data is properly received only if the channel statuses of the access point (AP) and the receive station (STA) are identical. If the AP sees an idle channel but the scheduled communication station STA 104 does not, the downlink reception at the communication station STA 104 is subject to interference, similar to interference resulting from transmitting a data packet without RTS/CTS protection in legacy Wi-Fi. The benefit of RTS/CTS may not be significant for short packet transmission because the RTS/CTS overhead is comparable to the retransmission of the short packet. Namely, the transmission can take the risk to send the short packet without the RTS/CTS protection and rely on the retransmission if the initial transmission failed. However, for long packets such as the aggregated packets having 3-4 micro-seconds (ms) transmission durations, the throughput without the RTS/CTS protection is much lower than that with the RTS/CTS protection.

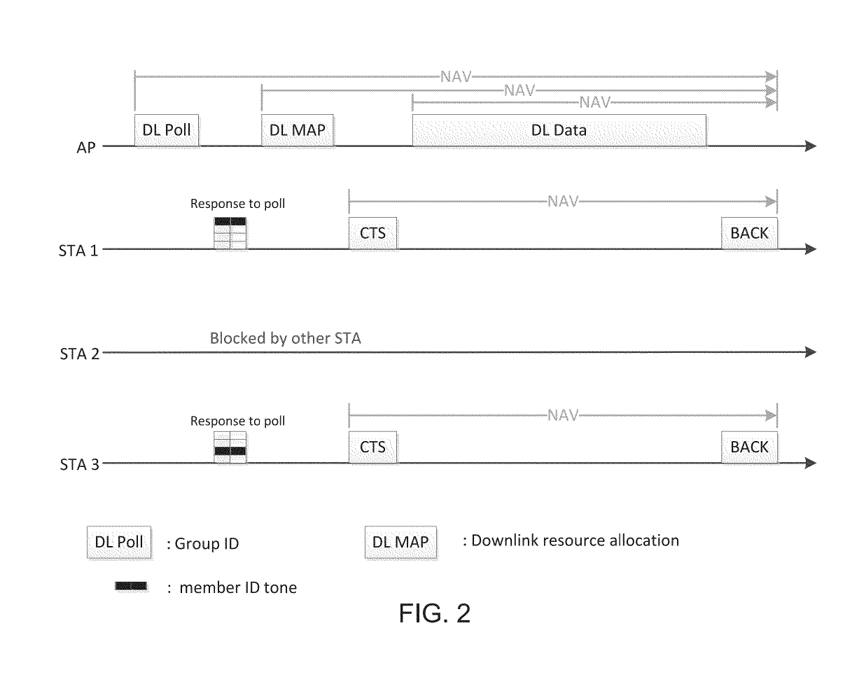

OFDMA is another feature of 802.11ax. OFDMA can experience reception jamming if the AP 102 does not know the CCA status of the communication station STA 104 or the STA does not reserve the channel for receiving long packets. Certain methods and apparatus for improving efficiency in DL MU-MIMO, DL OFDMA, and UL MU-MIMO of 802.11ax HEW are detailed in FIGS. 2-8.

FIGS. 2-8 illustrate certain embodiments of an AP polling the STAs for their clear-channel-assessment (CCA) statuses and then transmitting a downlink schedule, an uplink schedule or an aggregated downlink/uplink schedule to the pertinent STAs. After receiving the schedule, the scheduled STAs can transmit coherent channel reservation frames such as CTSs simultaneously for preventing or minimizing interference with minimum overhead. In one embodiment, the poll from the AP may be triggered by an STA that may acquire the channel. For example, a STA may send an RTS for sending data to the AP. Since the AP needs to receive the data from the requesting STA, the AP may want to receive data from other STAs. Therefore, the single user RTS may trigger the AP to initiate the multiuser transmission or reception. In another embodiment, the poll may be sent alone or together with other message/data in a piggybacked fashion. Although the term “poll” is referred to in the present disclosure, the term “poll” may be referred to as a “request” or “call” in some standards or protocols, and therefore would be covered by example embodiments disclosed.

Turning now to the embodiment of FIG. 2, DL MU-MIMO operations are illustrated where users or STAs are scheduled before a channel is reserved. Moving from left to the right, the first two operations are for the access point (AP) to learn about which mobile stations (STAs) are ready to receive data. The third and the fourth operations are for the AP to notify the scheduled STAs and for the scheduled STAs to reserve the channel. In the fourth operation, the scheduled STA sends a packet to reserve the channel for its downlink reception. This operation may be crucial for long packet transmissions. It can be noticed, however, that four transmit/receive turnarounds and four channel training preambles are used for the scheduling and channel reservation in FIG. 2.

According to one example embodiment, the “Response to poll” and “CTS” may be combined, and the “DL MAP” and “DL Data” may be combined in FIG. 2, to save two transmit/receive turnarounds and two channel training preambles, which correspond to about 48 micro seconds in total. This can be a significant saving for an 80 MHz channel in a 5 GHz band, for example, because the data burst would be short, for example, about 1 ms.

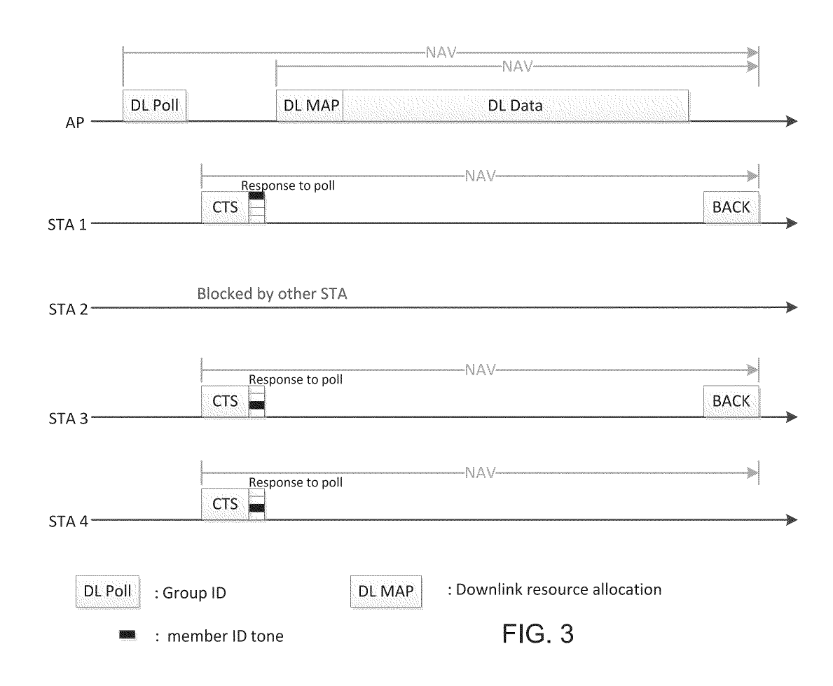

A new scheme, according to one example embodiment, is shown in FIG. 3, for example. As shown, STAs 1, 3, and 4 are ready to receive downlink data after receiving the downlink poll. They may see idle channels or channels with interferences small enough. Unlike FIG. 2, they first send packets to reserve the channels for their downlink data. The reservation packet can be a CTS packet or other types of packet, which can set the network allocation vector (NAV) of other devices. For high efficiency, the reservation packets can be sent simultaneously with the same content and physical layer signal format. For properly setting the AGC of the AP, the reservation packet may be sent with different cyclic delays. The cyclic delays may be randomly picked by the responding STAs using the timing information (e.g. the OFDM or OFDMA symbol boundary) acquired from the poll packet. For example, coherent CTS with different cyclic delays across STAs may be sent to improve efficiency. This helps the AP to receive the poll response right after the reservation packet. Since the AGC of AP is already set properly using the preambles of the reservation packet, the poll response signal can be sent immediately without AGC training preambles.

Multiple STAs can send their poll responses simultaneously using FDMA or CDMA or TDMA or combinations thereof. If CDMA is used, for example, cyclic delays may not be needed across users and their antennas. The CDMA code without the added delay may allow the AP to measure the propagation delays among the responding users. The AP can use the measured delays for adjusting the timing advance at the user such that the symbol boundaries of the uplink users are aligned. For example, when AP tells user A to send its packet 1 microsecond earlier and tells user B to send its packet 0.5 microsecond later. Since the poll response is appended to a legacy packet e.g., the channel reservation packet (e.g., CTS), legacy devices can decode the channel reservation packet without any problems. Compared to FIG. 2, the poll response signal is shorter in FIG. 3 because the AGC preamble is removed. The downlink allocation packet denoted by “DL MAP” in the figures can be combined with the downlink data packet e.g. as part of the PHY header. Although the poll response may be placed before the reservation packet, the poll response may interfere with the reception of the reservation packet at legacy devices. Therefore, sending the reservation before the poll response is preferred, although not necessary.

Going back to FIG. 2, two operations were introduced therein, transmission scheduling and channel reservation. The two operations were run separately. As this incurs overheads due to turnaround and channel training, certain embodiments may partially combine the two operations for reducing the overheads. As a result of the new arrangement, two turnaround gaps and two channel training preambles can be saved, thereby improving efficiency.

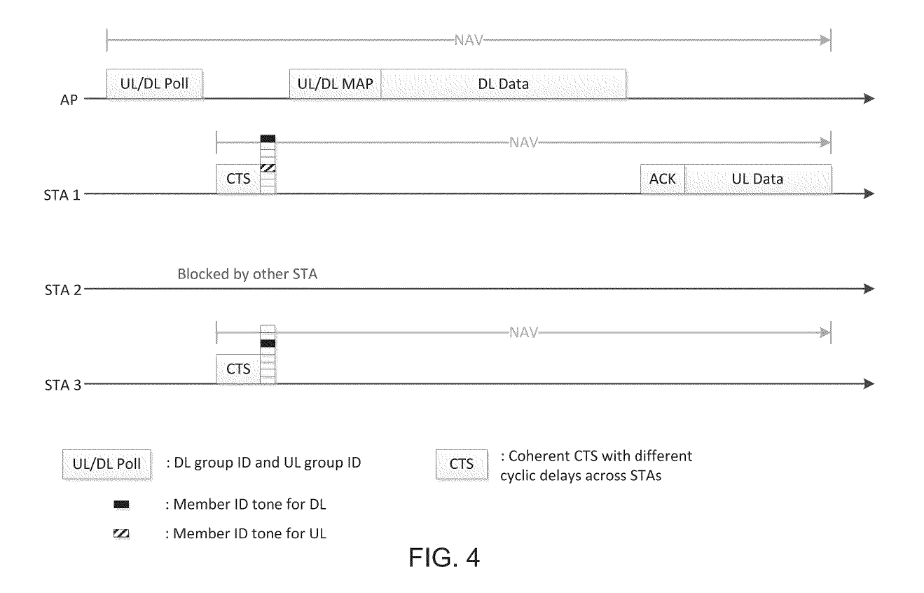

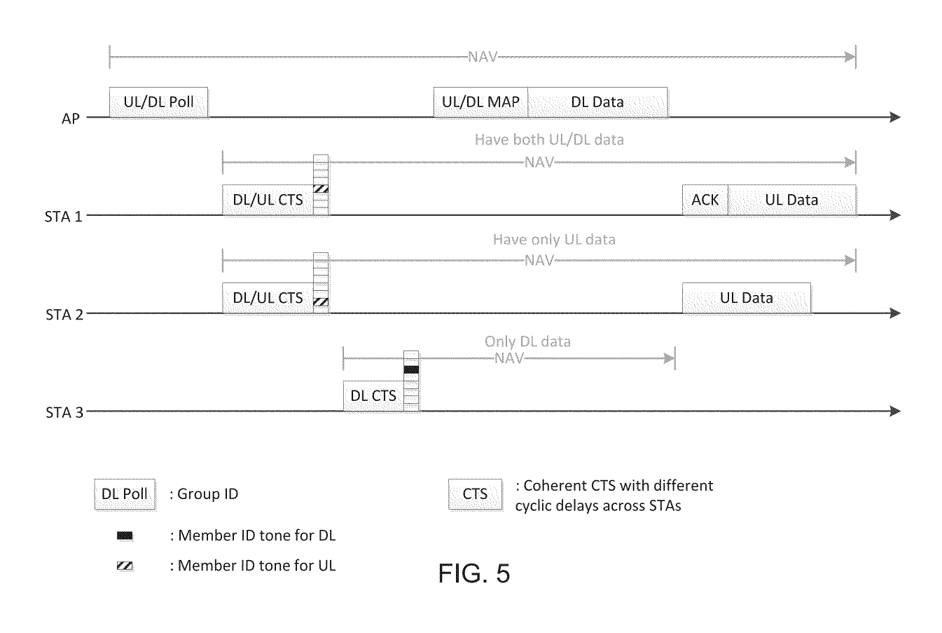

When downlink and uplink are jointly scheduled, the instant methods and systems can be applied as shown in FIGS. 4 and 5, for example. From the left to the right in FIG. 4, the AP first polls the STAs. The poll may ask a specific set of STAs whether they are ready to send uplink data. In addition, the poll may ask another or the same set of STAs whether they are ready to receive downlink data. After receiving the poll, the STAs may send a packet to reserve the channel if they are ready to either send uplink or receive downlink. The reservation packet may have the same physical layer format and can be sent simultaneously. Immediately after or preceding the reservation packet without any gap, for example, the poll response can be sent. The response tells the AP whether an STA is able to participate in the downlink or uplink. For higher efficiency, the responses from the different STAs may share the channel by FDMA or CDMA or TDMA or combinations thereof. In FIGS. 2-5, FDMA is illustrated only for illustrative purposes. In FIG. 4, however, the acknowledgement of the downlink data is piggybacked in the uplink data transmission as shown on the right of the figures for STA1, for example.

According to one example embodiment, a tone may be allocated for an STA's uplink (or downlink). A polled STA may put power on its allocated tone to signal its readiness for uplink (or downlink) as shown in FIG. 4, for example.

Some responded STAs may not get scheduled due to various reasons (e.g., AP may not have enough antennas). However, the STA always reserves the channel assuming it always gets served if it responds. The responded but unserved STA may cause a waste in spatial reuse because it may block the transmission in its neighborhood. To minimize the waste, the AP can limit the number of STAs in the poll list or select those STAs that are likely to be ready.

Besides the unserved STA, there can be another waste due to the channel overbook. Not all responded STAs need both downlink and uplink services but they all reserve the channel for both the downlink and the uplink as shown in FIG. 4, for example. This waste can be reduced by sending two separated bursts of channel reservations, one for both downlink and uplink and the other only for the earlier link e.g. the downlink as shown in FIG. 5. Three separated bursts of channel reservations may be used; one for both downlink and uplink, one for downlink only, and one for uplink only, for example.

In FIG. 5, STAs 1 and 2 need the latter link i.e. the uplink. They reserve the channel simultaneously in the first reservation burst. Since STA 3 only needs the earlier link i.e. the downlink, it reserves the channel for a shorter duration in the other burst. For reducing overhead, the poll packet e.g. “DL Poll” or “UL/DL Poll” in the figures may not be sent as a separate packet. The poll message may be piggybacked by other types of packets such as data packet or ACK packet or acknowledgement request packet, for example.

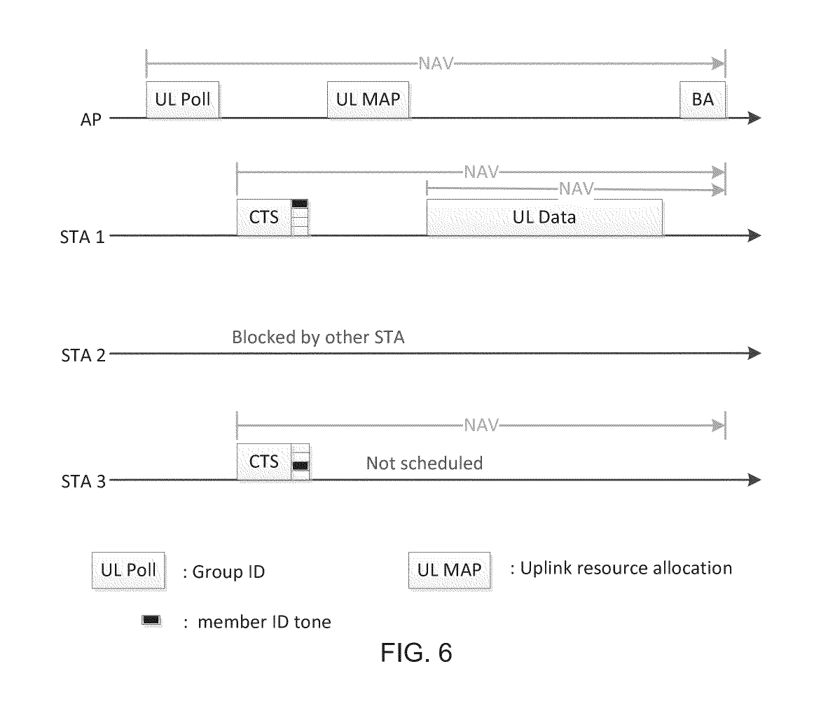

Combining the channel reservation with the poll response can be applied to uplink only case as shown in FIG. 6, for example. The polled STA can quickly grab the channel after the poll. However, if the STAs don't reserve the channel after the poll and reserve the channel in the uplink data packet, they have a small chance losing the channel to someone else between the poll response and the uplink transmission.

As described in the above example embodiments, the methods, apparatuses, and systems described herein can be applied to any 802.11 downlink MU-MIMO as well as uplink MU-MIMO, either separately or simultaneously. In addition, the methods, apparatuses, and systems described herein can be applied to any 802.11 downlink OFDMA as well as uplink OFDMA, either separately or simultaneously. Furthermore, the methods, apparatuses, and systems described herein can be applied to any combination of MU-MIMO and OFDMA in either uplink or downlink.

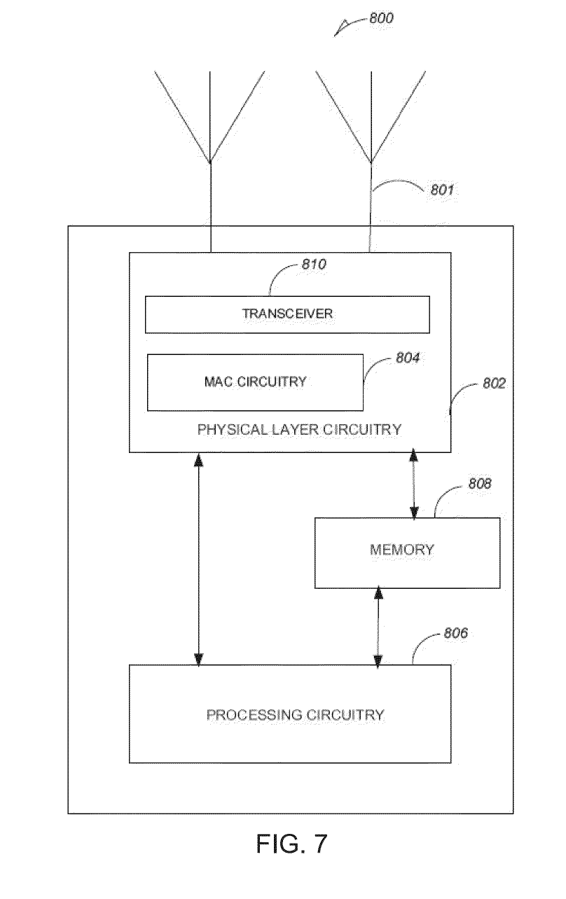

FIG. 7 shows a functional diagram of an exemplary communication station 800 in accordance with some embodiments. In one embodiment, FIG. 7 illustrates a functional block diagram of a communication station that may be suitable for use as an AP 102 (FIG. 1) or communication station STA 104 (FIG. 1) in accordance with some embodiments. The communication station 800 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 800 may include physical layer circuitry 802 having a transceiver 810 for transmitting and receiving signals to and from other communication stations using one or more antennas 801. The physical layer circuitry 802 may also include medium access control (MAC) circuitry 804 for controlling access to the wireless medium. The communication station 800 may also include processing circuitry 806 and memory 808 arranged to perform the operations described herein. In some embodiments, the physical layer circuitry 802 and the processing circuitry 806 may be configured to perform operations detailed in FIGS. 2-6.

In accordance with some embodiments, the MAC circuitry 804 may be arranged to contend for a wireless medium and configure frames or packets for communicating over the wireless medium and the physical layer circuitry 802 may be arranged to transmit and receive signals. The physical layer circuitry 802 may include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the physical layer circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device may, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

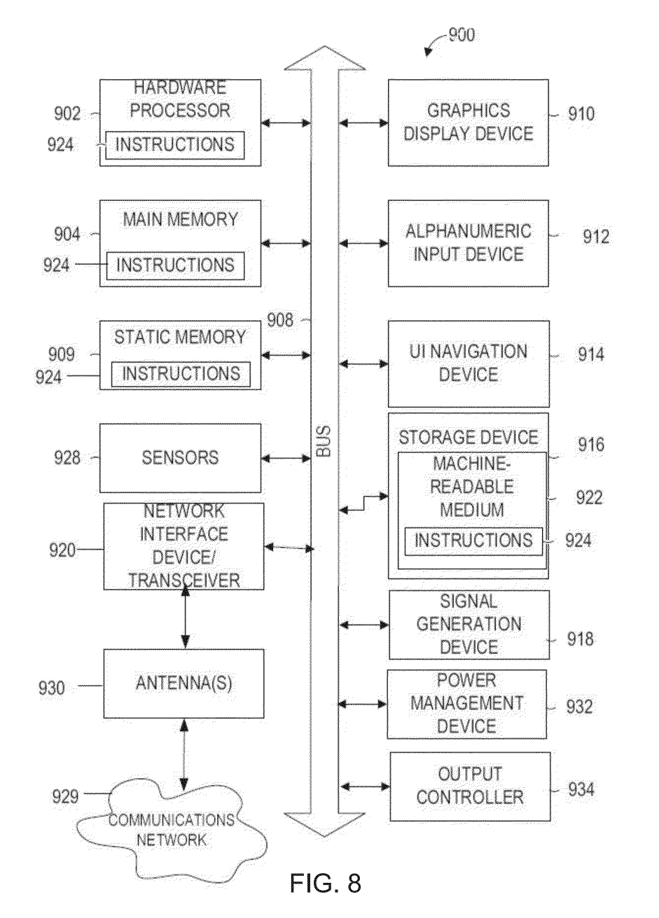

FIG. 8 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912 and UI navigation device 914 may be a touch screen display. The machine 900 may additionally include a storage device (i.e., drive unit) 916, a signal generation device 918 (e.g., a speaker), a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium includes a machine readable medium with a plurality of particles having resting mass. Specific examples of massed machine readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, DensiFi and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible media to facilitate communication of such software.

While there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method operations, which perform substantially the same function in substantially the same way to achieve the same results, are within the scope of the disclosure. Moreover, it should be recognized that structures and/or elements and/or method operations shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

### EXAMPLES

Examples of the disclosure relate to fast channel reservation for Wi-Fi. One example may be a communication station arranged for Clear Channel Assessment (CCA) channel status reporting, the communication station including physical layer circuitry, memory and processing elements to receive, from an Access Point (AP), a downlink poll, reserve a channel for downlink data by transmitting a packet to the AP, transmit a response to the downlink poll immediately following or preceding the packet, and receive, from the AP, a downlink schedule carrying notification of the downlink data from the AP. The response to the poll may be transmitted without a training preamble. The packet may be a Clear to Send (CTS) frame.

Another example may be a non-transitory computer readable storage device including instructions stored thereon, which when executed by one or more processor(s) of a communication station, cause the communication station to perform operations to receive, from an Access Point (AP), a downlink poll, reserve a channel for downlink data by transmitting a packet to the AP, transmit a response to the downlink poll immediately following or preceding the packet, and receive, from the AP, a downlink schedule carrying notification of the downlink data from the AP. The poll may be transmitted without a training preamble. The packet may be a Clear to Send (CTS) frame.

Another example may be an Access Point (AP) arranged for Clear Channel Assessment (CCA) channel status report polling, the AP including physical layer circuitry, memory and processing elements to transmit, to a communication station, a downlink poll, receive from the communication station, a packet for reserving a channel for downlink data, receive from the communication station a response to the downlink poll immediately following or preceding the packet, and transmit a downlink schedule carrying notification of the downlink data from the AP to the communication station. The AP may receive responses from multiple communication stations simultaneously using Frequency Division Multiple Access or Code Division Multiple Access. The AP may also receive responses from multiple communication stations sequentially using Time Division Multiple Access. The downlink data may be transmitted immediately following or preceding the downlink schedule.

Another example may be a non-transitory computer readable storage device including instructions stored thereon, which when executed by one or more processor(s) of an Access Point (AP), cause the AP to perform operations to transmit, to a communication station, a downlink poll, receive from the communication station, a packet for reserving a channel for downlink data, receive from the communication station a response to the downlink poll immediately following or preceding the packet, and transmit a downlink schedule carrying notification of the downlink data from the AP to the communication station. The AP may receive responses from multiple communication stations simultaneously using Frequency Division Multiple Access or Code Division Multiple Access. The AP may also receive responses from multiple communication stations sequentially using Time Division Multiple Access. The downlink data may be transmitted immediately following or preceding the downlink schedule.

A communication station arranged for Clear Channel Assessment (CCA) channel status reporting, the communication station including physical layer circuitry, memory and processing elements to receive, from an Access Point (AP), an uplink poll, reserve a channel for uplink data by transmitting a packet to the AP, transmit a response to the uplink poll immediately following or preceding the packet, and receive, from the AP, an uplink schedule. The poll may be transmitted without a training preamble. The channel reservation packet may be a Clear to Send (CTS) frame.

Another example may be a non-transitory computer readable storage device including instructions stored thereon, which when executed by one or more processor(s) of a communication station, cause the communication station to perform operations to receive, from an Access Point (AP), an uplink poll, reserve a channel for uplink data by transmitting a packet to the AP, transmit a response to the uplink poll immediately following or preceding the packet, and receive, from the AP, an uplink schedule. The poll may be transmitted without a training preamble. The channel reservation packet may be a Clear to Send (CTS) frame.

Another example may be an Access Point (AP) arranged for Clear Channel Assessment (CCA) channel status report polling, the AP including physical layer circuitry, memory and processing elements to transmit, to a communication station, an uplink poll, receive from the communication station, a packet for reserving a channel for uplink data, receive from the communication station a response to the uplink poll immediately following or preceding the packet, and transmit an uplink schedule to the communication station. The AP may receive responses from multiple communication stations simultaneously using Frequency Division Multiple Access or Code Division Multiple Access. The AP may also receive responses from multiple communication stations sequentially using Time Division Multiple Access. The uplink data may be transmitted immediately following or preceding the uplink schedule.

Another example may be a non-transitory computer readable storage device including instructions stored thereon, which when executed by one or more processor(s) of an Access Point (AP), cause the AP to perform operations to transmit, to a communication station, an uplink poll, receive from the communication station, a packet for reserving a channel for uplink data, receive from the communication station a response to the uplink poll immediately following or preceding the packet, and transmit an uplink schedule to the communication station. The AP may receive responses from multiple communication stations simultaneously using Frequency Division Multiple Access or Code Division Multiple Access. The AP may also receive responses from multiple communication stations sequentially using Time Division Multiple Access. The uplink data may be transmitted immediately following or preceding the uplink schedule.

What is claimed is:

1. A communication station arranged for Clear Channel Assessment (CCA) channel status reporting, the communication station comprising physical layer circuitry, memory and processing elements to:
receive, from an Access Point (AP), a downlink poll;
reserve a channel for downlink data by transmitting a packet to the AP;
transmit a response to the downlink poll immediately following or preceding the packet; and
receive, from the AP, a downlink schedule carrying notification of the downlink data from the AP.

2. The communication station of claim 1, wherein response to the poll is transmitted without a training preamble.

3. The communication station of claim 1, wherein the packet is a Clear to Send (CTS) frame.

4. A non-transitory computer readable storage device including instructions stored thereon, which when executed by one or more processor(s) of a communication station, cause the communication station to perform operations to:
receive, from an Access Point (AP), a downlink poll;
reserve a channel for downlink data by transmitting a packet to the AP;
transmit a response to the downlink poll immediately following or preceding the packet; and
receive, from the AP, a downlink schedule carrying notification of the downlink data from the AP.

5. The non-transitory computer readable storage device of claim 4, wherein response to the poll is transmitted without a training preamble.

6. The non-transitory computer readable storage device of claim 4, wherein the packet is a Clear to Send (CTS) frame.

7. An Access Point (AP) arranged for Clear Channel Assessment (CCA) channel status report polling, the AP comprising physical layer circuitry, memory and processing elements to:
transmit, to a communication station, a downlink poll;
receive from the communication station, a packet for reserving a channel for downlink data;
receive from the communication station a response to the downlink poll immediately following or preceding the packet; and
transmit a downlink schedule carrying notification of the downlink data from the AP to the communication station.

8. The AP of claim 7, further arranged to receive responses from multiple communication stations simultaneously using Frequency Division Multiple Access or Code Division Multiple Access.

9. The AP of claim 7, further arranged to receive responses from multiple communication stations sequentially using Time Division Multiple Access.

10. The AP of claim 7, wherein the downlink data is transmitted immediately following or preceding the downlink schedule.

11. A non-transitory computer readable storage device including instructions stored thereon, which when executed by one or more processor(s) of an Access Point (AP), cause the AP to perform operations to:
transmit, to a communication station, a downlink poll;
receive from the communication station, a packet for reserving a channel for downlink data;
receive from the communication station a response to the downlink poll immediately following or preceding the packet; and
transmit a downlink schedule carrying notification of the downlink data from the AP to the communication station.

12. The non-transitory computer readable storage device of claim 11, further arranged to receive responses from multiple communication stations simultaneously using Frequency Division Multiple Access or Code Division Multiple Access.

13. The non-transitory computer readable storage device of claim 11, further arranged to receive responses from multiple communication stations sequentially using Time Division Multiple Access.

14. The non-transitory computer readable storage device of claim 11, wherein the downlink data is transmitted immediately following or preceding the downlink schedule.

15. A communication station arranged for Clear Channel Assessment (CCA) channel status reporting, the communication station comprising physical layer circuitry, memory and processing elements to:
receive, from an Access Point (AP), an uplink poll;
reserve a channel for uplink data by transmitting a packet to the AP;
transmit a response to the uplink poll immediately following or preceding the packet; and
receive, from the AP, an uplink schedule.

16. The communication station of claim 15, wherein response to the poll is transmitted without a training preamble.

17. The communication station of claim 15, wherein the channel reservation packet is a Clear to Send (CTS) frame.

18. A non-transitory computer readable storage device including instructions stored thereon, which when executed by one or more processor(s) of a communication station, cause the communication station to perform operations to:
receive, from an Access Point (AP), an uplink poll;
reserve a channel for uplink data by transmitting a packet to the AP;
transmit a response to the uplink poll immediately following or preceding the packet; and
receive, from the AP, an uplink schedule.

19. The non-transitory computer readable storage device of claim 18, wherein response to the poll is transmitted without a training preamble.

20. The non-transitory computer readable storage device of claim 18, wherein the channel reservation packet is a Clear to Send (CTS) frame.

21. An Access Point (AP) arranged for Clear Channel Assessment (CCA) channel status report polling, the AP comprising physical layer circuitry, memory and processing elements to:
transmit, to a communication station, an uplink poll;
receive from the communication station, a packet for reserving a channel for uplink data;
receive from the communication station a response to the uplink poll immediately following or preceding the packet; and
transmit an uplink schedule to the communication station.

22. The AP of claim 21, further arranged to receive responses from multiple communication stations simultaneously using Frequency Division Multiple Access or Code Division Multiple Access.

23. The AP of claim 21, further arranged to receive responses from multiple communication stations sequentially using Time Division Multiple Access.

24. The AP of claim 21, wherein the uplink data is transmitted immediately following or preceding the uplink schedule.

25. A non-transitory computer readable storage device including instructions stored thereon, which when executed by one or more processor(s) of an Access Point (AP), cause the AP to perform operations to:
transmit, to a communication station, an uplink poll;
receive from the communication station, a packet for reserving a channel for uplink data;
receive from the communication station a response to the uplink poll immediately following or preceding the packet; and
transmit an uplink schedule to the communication station.

26. The non-transitory computer readable storage device of claim 25, further arranged to receive responses from multiple communication stations simultaneously using Frequency Division Multiple Access or Code Division Multiple Access.

27. The non-transitory computer readable storage device of claim 25, further arranged to receive responses from multiple communication stations sequentially using Time Division Multiple Access.

28. The non-transitory computer readable storage device of claim 25, wherein the uplink data is transmitted immediately following or preceding the uplink schedule.
